(19) United States
(12) Patent Application Publication
(10) Pub. No.: US 2008/0237038 A1
(43) Pub. Date: Oct. 2, 2008

(54) Biostrip

(75) Inventors: Ya-Hsin Chuang, Taipei (TW); Hsin-Yi Lin, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: HEALTH & LIFE CO., LTD., Taipei (TW)

(21) Appl. No.: 11/782,601

(22) Filed: Jul. 24, 2007

(30) Foreign Application Priority Data
Nov. 24, 2006 (TW) 095143552

(51) Int. Cl. G01N 27/26; B01J 19/00

(52) U.S. Cl. 204/403.01; 422/68.1

(57) ABSTRACT

The invention discloses a biostrip for the determination of the health condition or disease infection of an organism. The biostrip of the invention comprises at least an insulating baseboard and a capillary channel. Said insulating baseboard has at least one surface and a printed electrode is disposed on the surface. Moreover, said capillary channel is disposed above the insulating baseboard and has at least two ends on which at least one fixation reaction area and an exhaust channel of at least one direction are disposed respectively. The exhaust channel is formed by making use of the thickness and the shape of the back gum. Therefore, the biostrip of the invention can retain the advantage of the siphon type test strip of requiring a micro-amount of sample and also avoid the complicated production process thereof.

### BACKGROUND OF THE INVENTION

1. Field of the Invention

The present invention is directed to a biostrip, and more particularly, to an alternate form of back gum on the cover of the biostrip.

2. Description of the Prior Art

With the fast development in technology, diagnoses for diseases are also greatly improved. However, most diagnoses rely on the assistance of medical care personnel and determinations have to be made with instrumental readings. They are time-consuming and cost inefficient and lots of human resources are required. In particular, to people who value privacy, health condition is considered to be part of their privacy. Before further seeking medical advice and help, they do not want their health condition disclosed to others. Moreover, for modern people who live a busy life, these steps of diagnosis are too complicated, and they look forward to a more convenient alternative. As it is common to use body fluids in the determination of health condition and the diagnosis of disease, various test strips for body fluid testing have been developed.

Generally speaking, common test strips are mainly for testing blood glucose. FIG. 1 is a diagram of a conventional blood glucose test strip. The test strip has a sampling area 10 to accommodate the blood drop as well as a placing portion 11 to accommodate a test paper 110. Between the sampling area and the placing portion, there is also a channel (not shown) to allow the blood in the sampling area 10 to reach the test paper 110 therethrough. A color change would then occur on the test paper 110. The test paper along with the test strip is then inserted in an instrument such as a hand-held analyzer of blood glucose or other diseases for reading to determine the test values of blood glucose or other diseases.

For a number of blood glucose test strips currently on the market, the method for adding the test sample is categorized in two major types: the dripping type and the siphon type (by capillary action). Test strip of the dripping type usually has a plastic mesh covering the reaction area. This means that a larger amount of sample is required and it has to be aggregated into a drop of blood so as to be dripped onto the reaction area with precision and in sufficient amount. It is quite inconvenient for the operator and an operational error can be easily made, which often leads to a waste of test strips. As for the test strip of the siphon type, since it works working by capillary action and the sample is automatically introduced to the reaction area upon contacting the sample inlet, the required sample amount is naturally much smaller. However, in the siphon designs of the siphon type test strips currently on the market, a hole is usually made on the opposite end from the sample inlet. Or, alternatively, air outlets are retained between the base material and the partition sheet of the siphon type test strip. Therefore, the production process required thereby is very complicated.

To keep the advantages of the siphon type test strip and to avoid its disadvantages at the same time, the inventors of the present invention have proposed a biostrip based on years of research and practical experience to meet the above said expectations.

### SUMMARY OF THE INVENTION

In view of the above, the object of the invention is to provide a biostrip which, in addition to retaining the above said advantage of the conventional siphon type test strip that requires a smaller amount of sample, can avoid the complicated production process of the conventional siphon type test strip.

To achieve the above object, the biostrip of the invention comprises at least an insulating baseboard and a capillary channel. Said insulating baseboard has at least one surface and a printed electrode can be disposed on the surface. Moreover, said capillary channel is disposed above the insulating baseboard and has at least two ends on which at least one fixation reaction area and an exhaust channel of at least one direction can be disposed respectively. The end with the fixation reaction area is used to contact the sample and the exhaust channel of one or more directions is used to expel air so as to have the sample diffused and absorbed onto the fixation reaction area. It should be noted that the exhaust channel can be formed by making use of the thickness and the shape of the back gum.

The biostrip of the invention further comprises an inlet to introduce the sample to the fixation reaction area. When the sample approaches the inlet, it can be rapidly introduced to the fixation reaction area and the air that is co-introduced can be expelled at the same time through the exhausting channel. A substrate of oxidation or reduction capacity is usually disposed on the fixation reaction area so as to perform a specific biochemical reaction with the sample and then produce an electronic transfer by the printed electrode. The biostrip of the invention can be combined with an electrochemical biosensor. The concentration of certain substrates in the sample can therefore be measured according to the electronic transfer and used as a reference for the determination of the health condition, disease or infection of the organism.

The technical characteristics of the invention and the effects achieved thereby are further illustrated with the following detailed description in conjunction with the preferred embodiments and the relevant drawings.

### BRIEF DESCRIPTION OF THE DRAWINGS

FIG. 1 is a diagram of a conventional blood glucose test strip;

FIG. 2 is a diagram of the capillary channel of the present invention;

FIG. 3 is a diagram of the interlining of the present invention; and

FIG. 4 is a diagram of the insulating baseboard of the present invention.

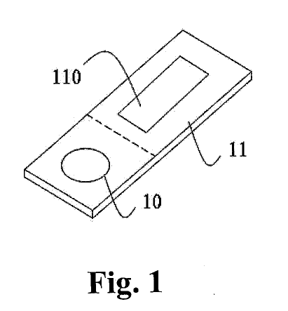

### DETAILED DESCRIPTION OF THE INVENTION

To further explicate the above objects, characteristics and advantages of the invention, the biostrip of the invention will be described in details in the following section with reference to the relevant drawings.

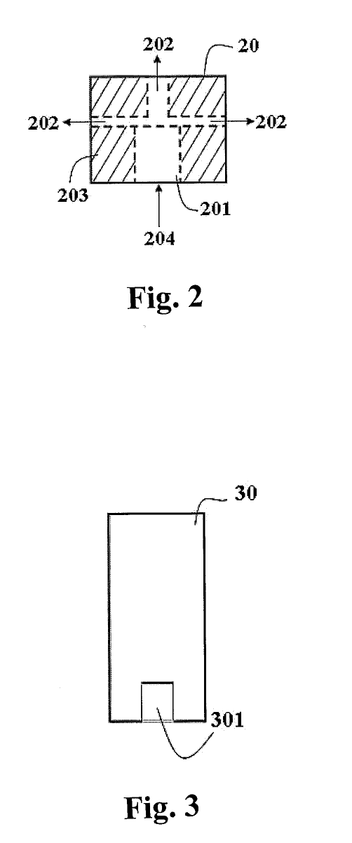

FIG. 2 is a diagram of the capillary channel 20 of the present invention. Said capillary channel 20 has at least two ends made by making use of the thickness of the back gum 203 (oblique lines) and the shape of the back gum 203. It is further disposed with at least one fixation reaction area 201 and an exhaust channel of at least one direction 202. The fixation reaction area 201 can be predisposed with a substrate of oxidation or reduction capacity so as to perform a specific biochemical reaction with the sample. Sample contact is made in the fixation reaction area 201. With air expelled from the exhausting channel in direction 202, the sample is introduced in direction 204 and then diffused and absorbed onto the fixation reaction area 201.

FIG. 3 is a diagram of the interlining of the present invention. Said interlining 30 has a breach 301 corresponding to the fixation reaction area 201 in FIG. 2. The thickness of the interlining 30 is used to increase the space of the fixation reaction area 201 so as to absorb sufficient amount of sample to perform the biochemical reaction.

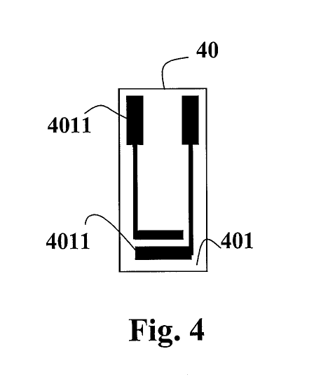

FIG. 4 is a diagram of the insulating baseboard 40 of the present invention. Said insulating baseboard 40 has at least one surface 401 and a printed electrode 4011 can be disposed on the surface 401.

It is to be noted that the combination of FIGS. 2, 3 and 4 is the diagram of the biostrip of the present invention. Namely, the fixation reaction area 201 of the capillary channel 20 in FIG. 2 is correspondingly disposed above the breach 301 of the interlining 30 in FIG. 3, and then the interlining 30 is disposed above the insulating baseboard 40 in FIG. 4.

Moreover, in the subject example, the biostrip should comprise an inlet (not shown). When the sample approaches the inlet, it can be rapidly introduced to the fixation reaction area 201 and the air that is co-introduced can be expelled from the exhaust channel of at least one direction 202. In the subject example, the sample can be blood, preferably. It is to be noted that although blood is considered the main sample applicable to the invention, the sample can further include plasma, urine, saliva, tear and the like of an organism and is not limited to blood.

Furthermore, in the subject example, human blood is used as the testing subject for the determination of health conditions and infection risks. Namely, a blood sample in micro unit (in μL) is collected from the fingertip, the earlobe or the vein to make contact with the above said inlet. Or, alternatively, the blood sample can be mixed with a given amount (in mL) of buffer before making contact with the above said inlet. The buffer can be an acid with a salt of an acid (such as KH₂SO₄) or a base with a salt of a base (such as NaHSO₄), which can react with the hydrogen ions added or removed to prevent a change of the pH and is made after adding sodium hydroxide and distilled water. When the blood sample is introduced through the capillary channel 20 to the fixation reaction area 201, a specific biochemical reaction occurs and an electronic transfer is produced to an electrochemical biosensor (not shown). The electrochemical biosensor receives such an electronic transfer to measure the concentration of a specific substrate in the sample so as to determine the health condition, disease or infection of the organism (for example, when an abnormal change in blood glucose level is observed).

The above description is provided for illustration only. It can be in no way construed as limitation to the present invention. Any modifications or changes without departing from the spirits of the invention are intended to be within the scope of the invention as defined by the appending claims.

### BRIEF DESCRIPTION OF THE ELEMENTS NUMERALS

10: sampling area;
11: placing portion;
110: test paper;
20: capillary channel;
201: fixation reaction area;
202: direction of the exhaust channel;
203: back gum;
204: direction of sample inlet;
30: interlining;
301: breach;
40: insulating baseboard;
401: surface; and
4011: printed electrode.

What is claimed is:

1. A biostrip for the determination of the health condition, disease infection or blood glucose level of an organism, said biostrip at least comprising:
an insulating baseboard which has at least one surface and a printed electrode is disposed on said surface; and
a capillary channel which is disposed above the insulating baseboard and has at least two ends on which at least one fixation reaction area and an exhaust channel of at least one direction are disposed respectively,
wherein the end with the fixation reaction area is used to contact the sample and the exhaust channel of one or more directions is used to expel air so as to have the sample diffused and absorbed onto the fixation reaction area.

2. The biostrip of claim 1, wherein the exhaust channel is formed by making use of the thickness and the shape of the back gum.

3. The biostrip of claim 1, wherein the biostrip further comprises an inlet.

4. The biostrip of claim 3, wherein the inlet is provided so that when the sample approaches the inlet, it can be rapidly introduced to the fixation reaction area and the air that is co-introduced can be expelled through the exhaust channel.

5. The biostrip of claim 1, wherein a substrate of oxidation or reduction capacity on the fixation reaction area so as to perform a specific biochemical reaction with the sample.

6. The biostrip of claim 5, wherein the specific biochemical reaction produces an electronic transfer by the printed electrode.

7. The biostrip of claim 6, wherein the biostrip can optionally be combined with an electrochemical biosensor so that the concentration of a specific substrate in the sample can be measured by the electronic transfer received by the electrochemical biosensor and used for the determination of the health condition, disease or infection of the organism.
